(19) United States
(12) Patent Application Publication
(10) Pub. No.: US 2008/0197150 A1
(43) Pub. Date: Aug. 21, 2008

(54) Refillable dropper suitable for liquid materials of any viscosity

(75) Inventor: Carlos Felix Beltrame, Ciudad de Buenos Aires (AR)

Correspondence Address: AMIN HALLIHAN, LLC, 444 NORTH ORLEANS, SUITE 400, CHICAGO, IL, 60610, US

(73) Assignee: Cintia Florencia Beltrame

(21) Appl. No.: 11/709,643

(22) Filed: Feb. 21, 2007

(51) Int. Cl. B67D 5/06; B65D 37/00; B65D 47/18

(52) U.S. Cl. 222/183; 222/420; 222/209; 222/214

(57) ABSTRACT

The present dropper comprises an inner container provided with two elastically deformable portions: an ejection drip portion and a suction filling portion; a pusher actuates on this inner container by means of a to-and-fro motion within an outer container. By removing the safety cover the pusher can be operated and, in turn, it actuates compressing the ejection drip portion of the inner container until the liquid material comes out through the drip opening of the drip nozzle. In order to refill the dropper, the inner container is removed, its drip nozzle is applied to the refill liquid material and the filling portion is cross-sectionally compressed and decompressed by suction.

### BACKGROUND OF THE INVENTION

1. Field of Invention

The present invention refers to the field of small containers mainly used for the dosified delivery of liquid materials or viscous substances. More particularly, it consists in a refillable dropper suitable for liquid materials of any viscosity which can be used for liturgical purposes as well as for the dosified delivery of substances of various viscosities in general.

2. Description of Prior Art

There are known devices as the one disclosed in the Patent Application FR2700316. In this case, it is an outer container with an elastically deformable tab which actuates on the bottom of an inner container.

Another known container is the one disclosed in the U.S. patent application Ser. No. 4,634,023. This container comprises an outer casing and an inner container. The inner container has only one elastically deformable bellows-shaped portion, so that it is used both for ejecting and refilling the content. It is kept in its position inside the outer casing by an inner ring and a support member having a flexible pressure portion. This pressure portion is externally exposed.

There is also a known device for the dosified delivery of adhesives disclosed in U.S. patent application Ser. No. 5,388,726. In this case, the outlet port has a protective cap having a clip so that it can be held in a pocket, for example.

An object of the present dropper is to provide a device suitable especially for both liturgical ceremonies, such as anointment with holy oil, and the dosified administration of various substances, such as medicine and the like.

### OBJECTS AND ADVANTAGES

The present dropper (the term “dropper” is to be understood in the most comprehensive sense, i.e. as the set of means which allow the dosified delivery of the contents) has the advantage of being suitable for liquid material of any viscosity. This is due to the presence of two elastically deformable portions in the inner container: an ejection portion and a suction portion.

Another advantage is the addition of position-fixing means which, by fixing the inner container with respect to the outer container, allow the dropper to work perfectly when it is activated to discharge drops.

Another advantage is the elimination of accidental liquid discharge. This is due to the fact that the inner ring and pressure support members are replaced by a more effective pusher and a safety cap which covers said pusher when the dropper is not in use.

Another object of the present dropper is to provide a small-size device which can be easily carried and be readily available to users in different activities. For example, when administering sacraments in liturgical activities, administering doses of substances such as medicine or perfume, applying liquid material of various characteristics, etc.

Another advantage is that the present dropper may have different cross-sectional configurations of the outer container, for example it may be flat, so that it can be carried by users in a pocket without bulging or causing inconveniences. This flat configuration does not impair its capacity, since the inner container is designed to follow the shape of the outer container, so that it can keep or increase its liquid holding capacity.

The ease to carry and handle this dropper is completed by a cap which, besides having a holding clip, also has means to be attached to laces, chains or key-rings.

### DESCRIPTION OF THE DRAWINGS

For the sake of clarity and understanding of the object of the invention, the present device is illustrated in different figures in which it has been represented in one of the preferred embodiments, by way of example and not by limitation:

FIG. 1 is a longitudinal section of an exploded view of the present dropper.

FIG. 2 is a longitudinal section of the present dropper assembled.

FIG. 3 is an elevational side view of the present dropper in the nozzle of which projecting position-fixing means can be seen.

FIG. 4 is a detail view of FIG. 3 showing the set of projecting position-fixing means in more detail.

FIG. 5 is a detail view in which the position-fixing means have a smaller mouth edge.

FIG. 6 is a detail view in which the position-fixing means have a ring configuration.

FIG. 7 is a longitudinal section of the present dropper in the nozzle of which recessing position-fixing means can be seen.

FIG. 8 is a detail view of FIG. 7 showing the projecting position-fixing means coupling with the recess formed by the end of the container.

FIG. 9 is an elevational side view of the inner container and the extension fitting.

FIG. 10 is an elevational side view of the inner container with its nozzle inserted in the mouth of the extension fitting.

FIG. 11 is an elevational side view of the present dropper showing its outer configuration.

FIG. 12 is an elevational side view of the present dropper with the cap removed from its position.

FIG. 13 is an elevational side view of the present dropper showing the removal of the safety cover on the pusher.

FIG. 14 is an elevational side view of the present dropper showing the pusher whereon pressure should be exerted.

FIG. 15 is an elevational side view like the one in FIG. 12 showing how the pressure on the pusher causes the liquid material to come out through the nozzle.

FIG. 16 is an elevational side view like the one in FIG. 13 showing the location of the inner container.

FIG. 17 is an elevational side view like the one in FIG. 14 showing how the pusher causes the compression of the inner container and the appearance of a drop.

FIG. 18 is a longitudinal section of the dropper showing how it is filled by activating the suction filling portion.

FIG. 19 is a longitudinal section of the inner container filled with liquid material.

FIG. 20 is an elevational side view and a top view of the cap in an embodiment in which the holding clip and the eyelet are formed.

FIG. 21 is an elevational side view and a top view of the cap in another embodiment in which the holding clip is fixed.

FIG. 22 is an elevational side view and a top view of the cap in an embodiment in which the holding clip and the eyelet are part of an added feature.

FIG. 23 comprises drawings A, B, C and D, wherein:

Drawing A is an elevational top view of the dropper in an embodiment in which its cross-sectional configuration is round;

Drawing B is an elevational top view of the dropper in an embodiment in which its cross-sectional configuration is flat and with curving side parameters;

Drawing C is an elevational top view of the dropper in an embodiment in which its cross-sectional configuration is flat and with flat side parameters; and

Drawing D is an elevational top view of the dropper in an embodiment in which its cross-sectional configuration is polygonal.

FIG. 24 is a perspective view of the flat dropper next to which the shape of its inner container, also flat, can be seen.

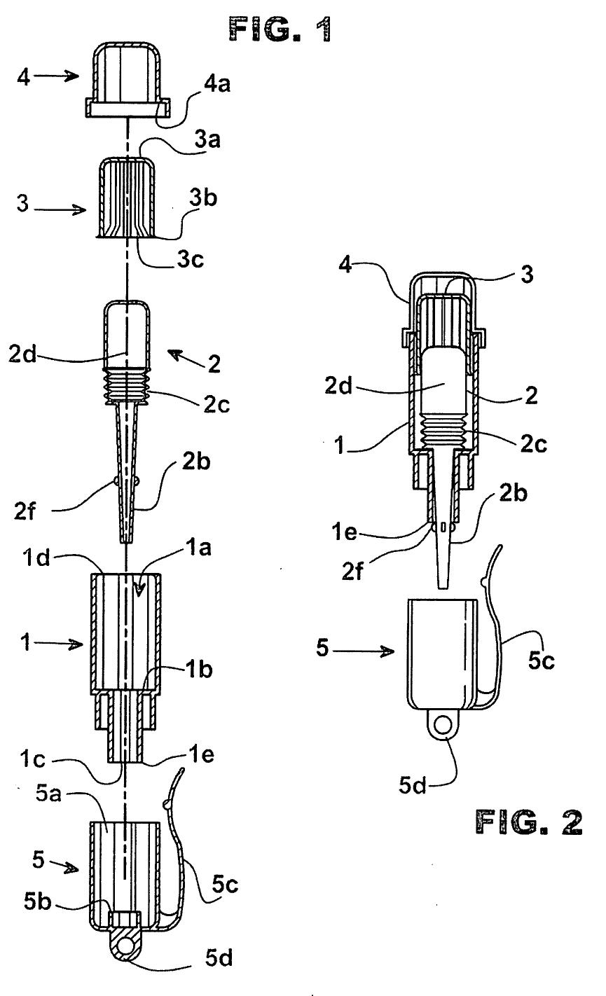

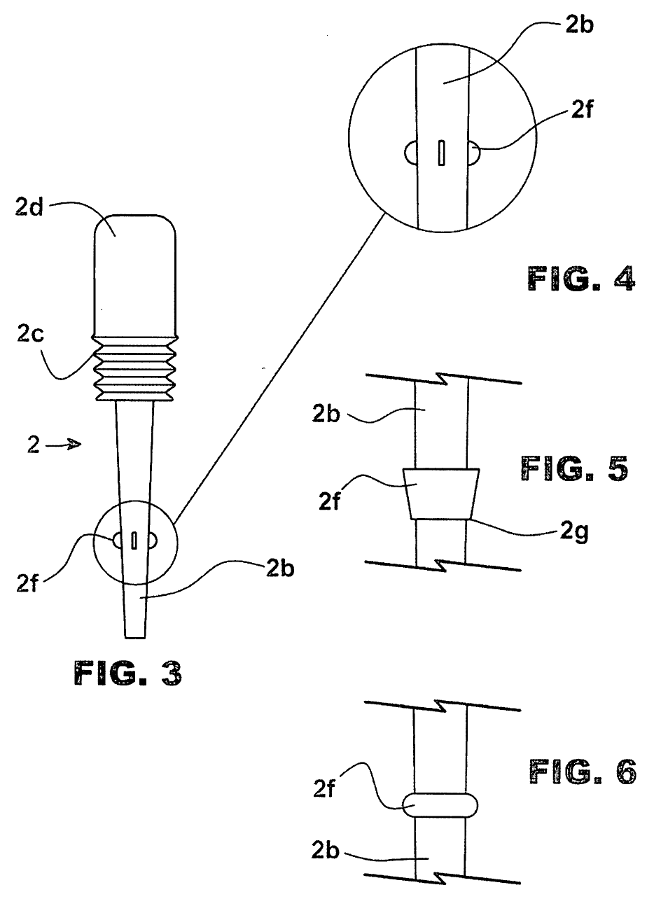

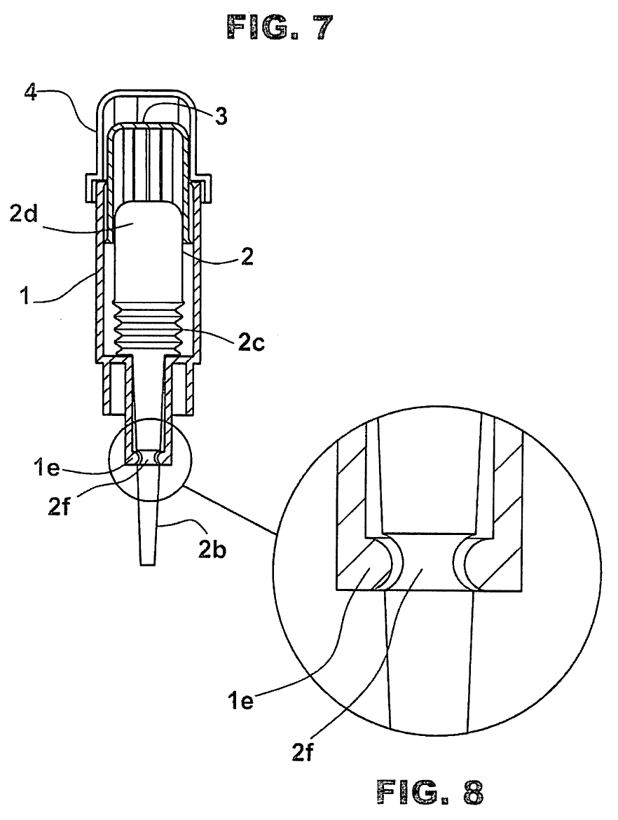

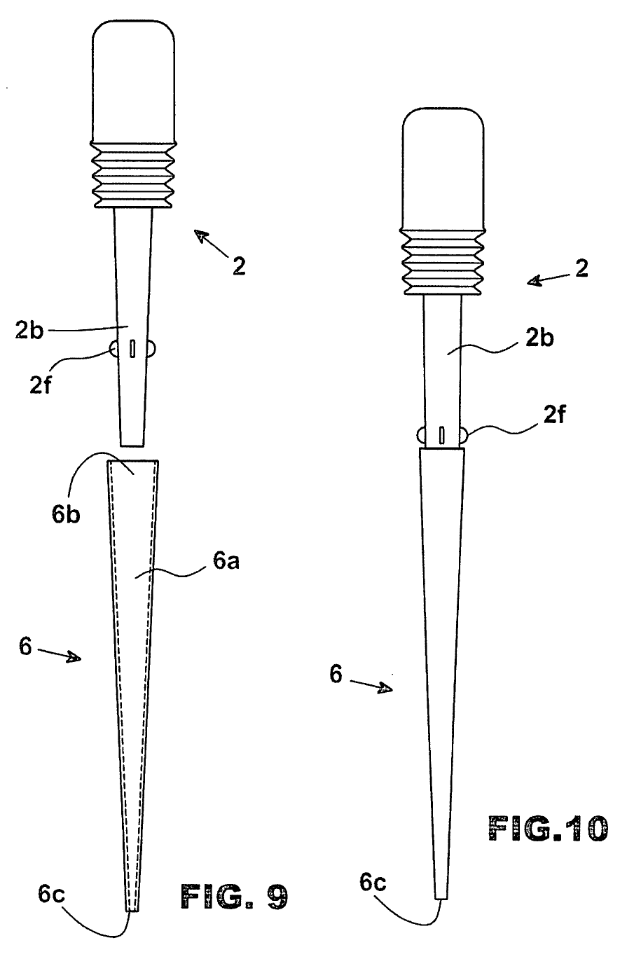

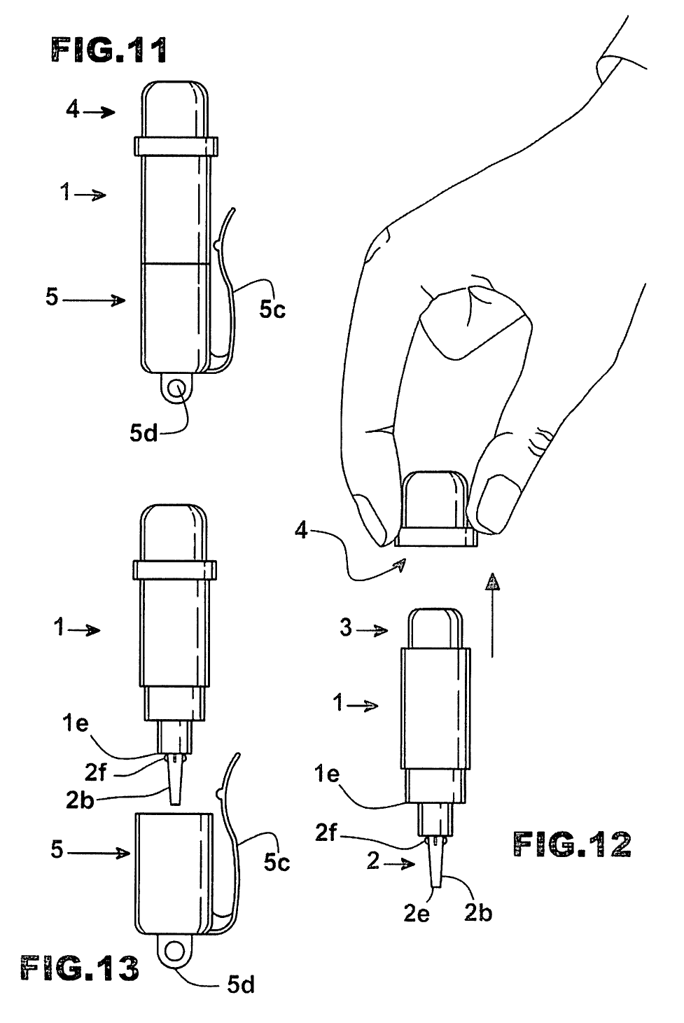

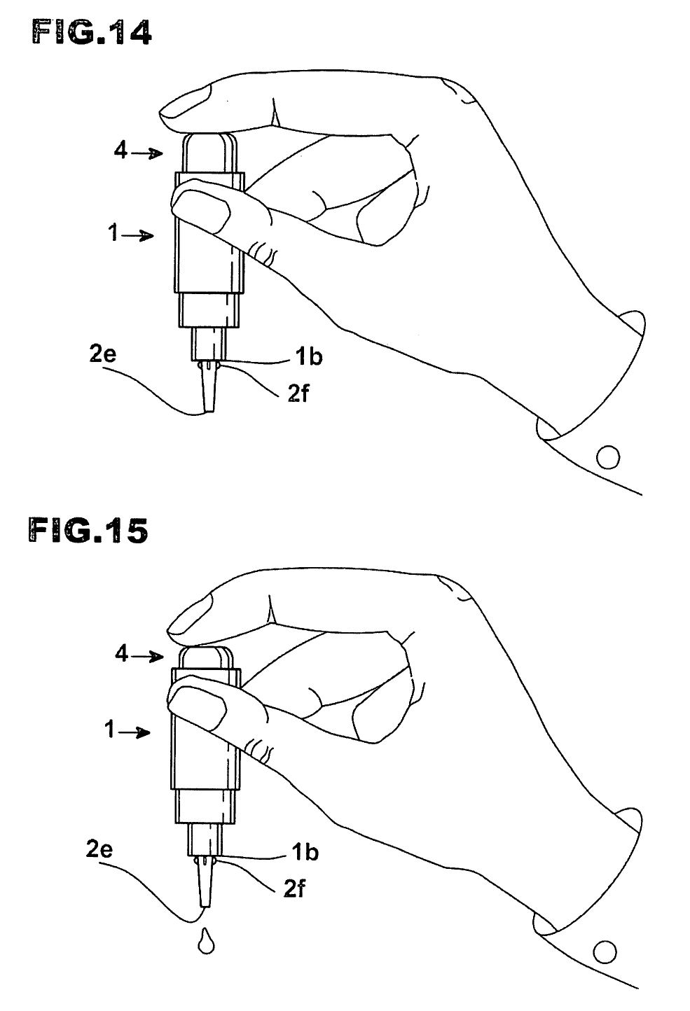

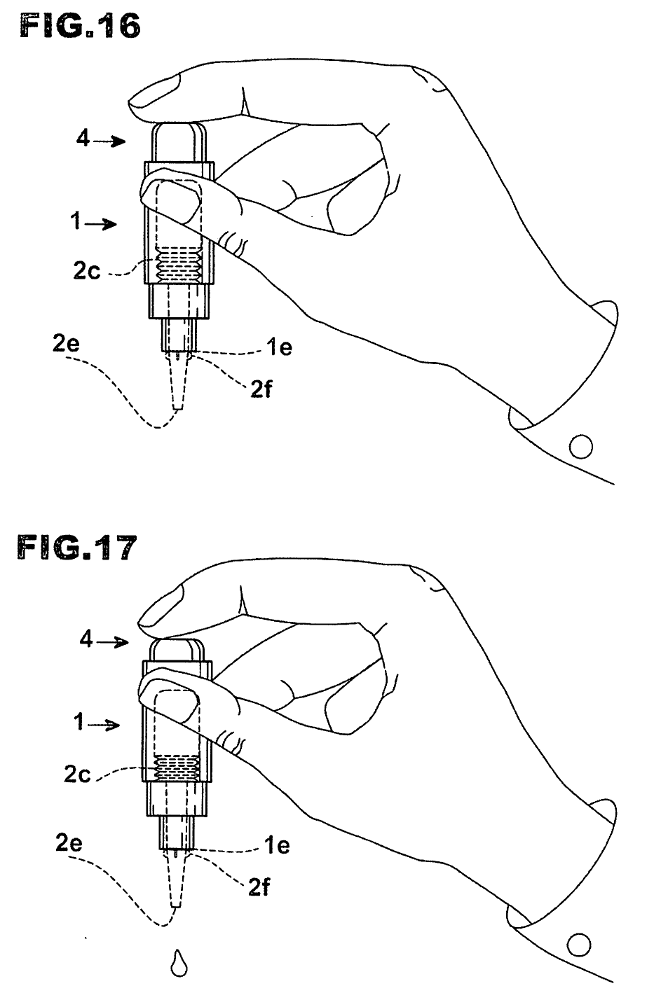

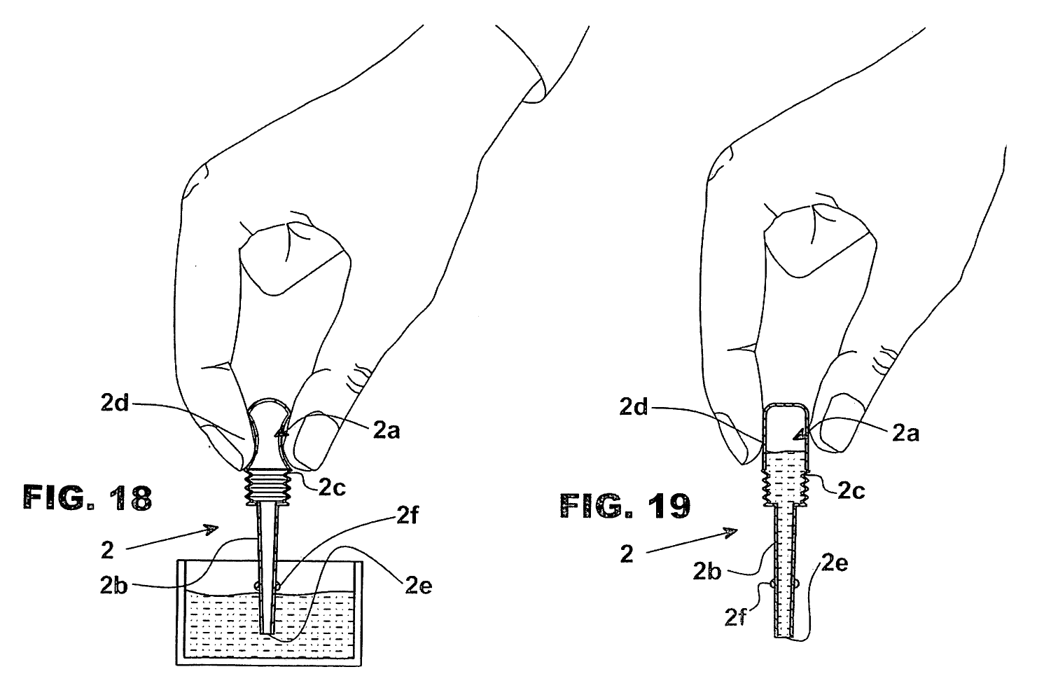

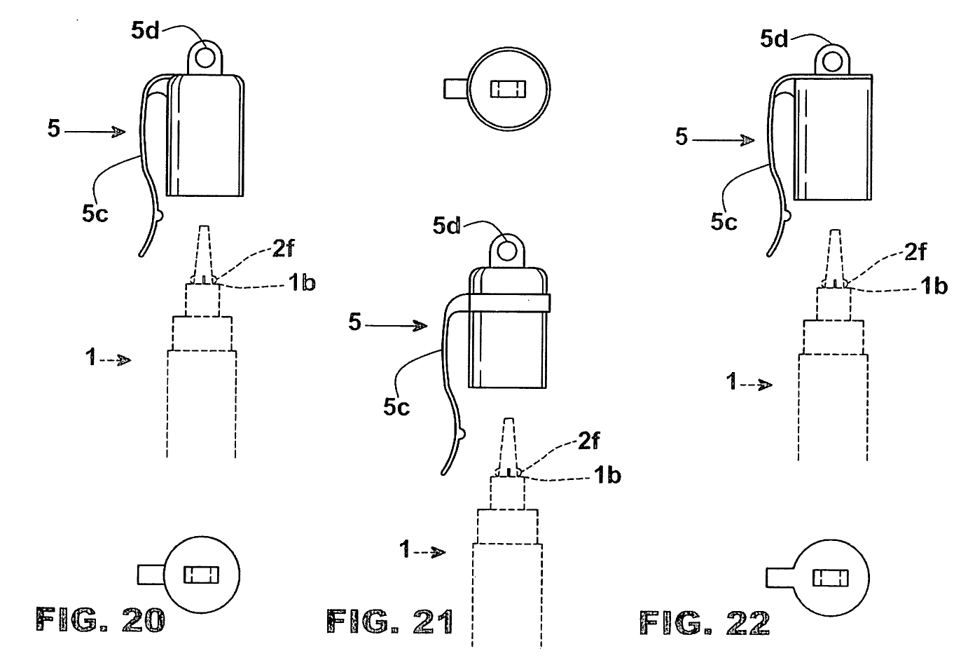

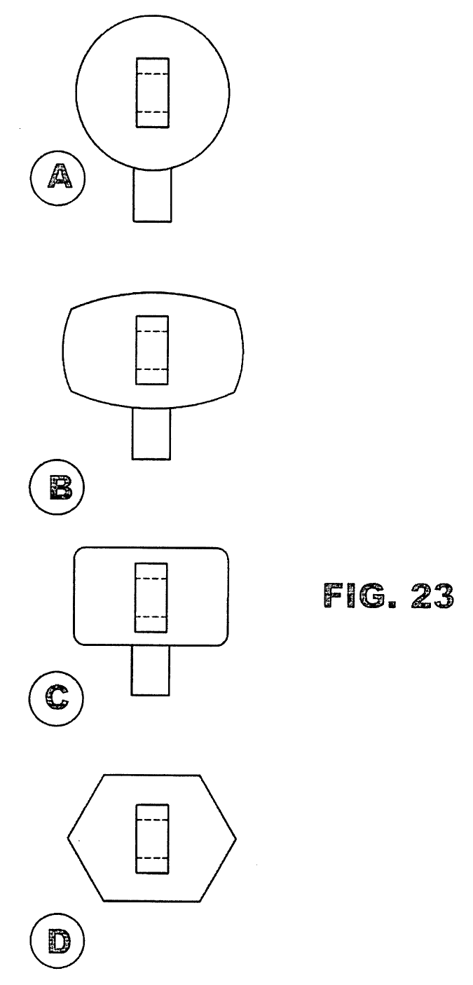

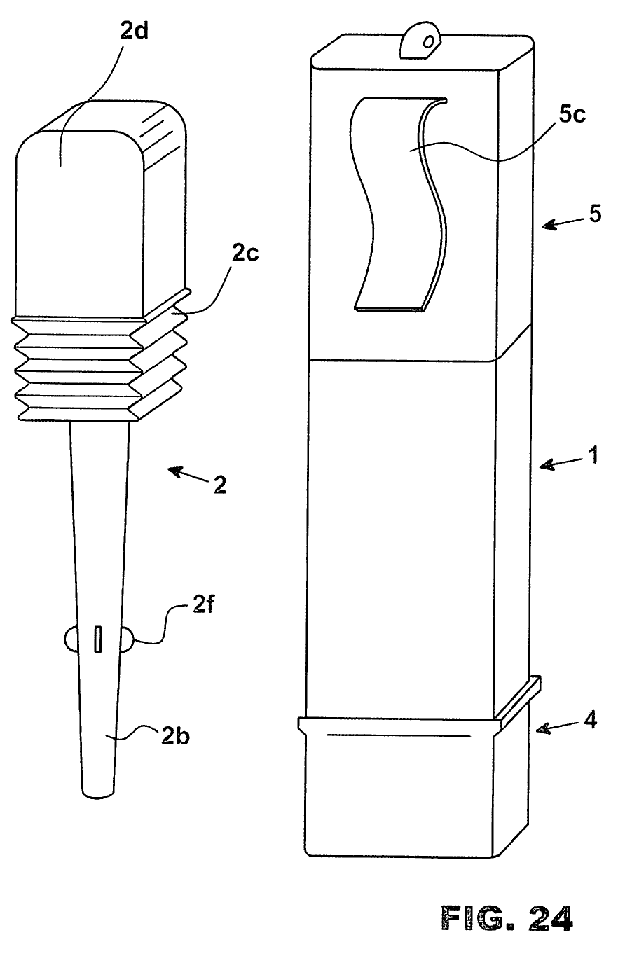

### REFERENCE NUMERALS IN DRAWINGS

(1) Outer container.

(1a) Inner cavity of the outer container (1).

(1b) Inner motion stop.

(1c) Insertion opening.

(1d) Inner flange [it actuates reciprocally with the outer flange of the pusher (3)].

(1e) End of outer container (1) [it actuates at the position-fixing means together with the respective fixing means of the nozzle].

(2) Inner container [elastically deformable}.

(2a) Filling cavity of the inner container (2).

(2b) Drip nozzle.

(2c) Ejection drip portion [longitudinally deformable].

(2d) Suction filling portion [cross-sectionally deformable].

(2e) Drip opening.

(2f) Position-fixing means.

(2g) Mouth edge.

(3) Pusher.

(3a) Pushing end.

(3b) Outer flange [it actuates reciprocally with the inner flange of the outer container (1)].

(3c) Pushing stop.

(4) Safety cover [it prevents the pusher (3) from being accidentally actuated].

(4a) Coupling edge [at the outer container (1)].

(5) Protection cap.

(5a) Wedge cavity [at the end of the outer container (1)].

(5b) Inner wedge [for drip nozzle].

(5c) Holding arm.

(5d) Eyelet.

(6) Extension fitting.

(6a) Extension conduit.

(6b) Extension mouth.

(6c) Extension nozzle.

### DETAILED DESCRIPTION

In general terms, the present invention consists in a refillable dropper suitable for liquid material of any viscosity comprising an inner container (2) having two elastically deformable portions: an ejection drip portion (2c) and a suction filling portion (2d); a pusher (3) actuates on this inner container (2) by means of a to-and-fro motion within an outer container (1). To operate properly, there are position-fixing means (1e) (2f) at the end of the outer container (1) and at the drip nozzle (2b) of the inner container (2).

More particularly, the present refillable dropper is for the dosified delivery of liquid material, regardless of its viscosity, so that it is suitable for liquid materials of any viscosity.

This refillable dropper comprises an outer container (1) which houses in its inner cavity (1a) the inner container (2). For this purpose, said outer container (1) has an inner motion stop (1b) and an insertion opening (1c) though which the drip nozzle (2b) emerges from the inner container (2) Said insertion opening (1c) finishes at an end (1e).

Said inner container (2) comprises two elastically deformable portions (2c) (2d). Adjacent to the drip nozzle (2b) there is an ejection drip portion (2c) having folds in a bellows-shape and which operates longitudinally in the inner container (2). At the opposite end of the drip nozzle (2b) there is a suction filling portion (2d) which operates cross-sectionally to said inner container (2).

The drip nozzle (2b) has position-fixing means (2f) which actuate against the end (1e) of the outer container (1) causing the inner container (2) to be fixed in its position with respect to said outer container (1).

These position-fixing means (2f) of the drip nozzle (2b) may project or recess. In the case of the projecting position-fixing means (2f), they may be: a set of ledges, a ring ledge or a ledge with a mouth edge (2g). These fixing means (2f) form the lock with the end (1e). In the case of the recessing position-fixing means (2f), they form the lock of the drip nozzle (2b) with one or more ledges formed at the end (1e) of the outer container (1).

A pusher (3) located at the pushing opening of the outer container (1) actuates on the inner container (2). This pusher (3) is a substantially rigid member, which can slide to and fro within the cavity of the outer container (1) and which has retention means linking it to said outer container (1). These retention means, which actuate reciprocally, consist of an inner flange (1b) of the outer container (1) and an outer flange (3b) of the pusher (3).

On the other hand, the outer container (1) has two opposing ends: a pushing end and a drip end. The pushing end acts as a connection with a safety cover (4), while the drip end acts as a connection with the protection cap (5).

The safety cover (4) is over the pusher (3), covering it and preventing its accidental operation.

As regards the protection cap (5), it may be provided with an elastic holding arm (5c) and an eyelet (5d). In different embodiments, these means may be formed, added and fixed; they may be part of an added member, fixed to the protection cap (5), etc.

Both for applications in places with difficult access and the refill in deep containers, the use of an extension fitting (6) has been provided. An extension conduit (6a) which starts at the extension mouth (6b) and ends at an extension nozzle (6c) runs through it.

The extension mouth (6b) is connected at the end portion of the drip nozzle (2b) of the inner container (2), using the position-fixing means (2f) as wedging stops of the extension fitting (6) in said drip nozzle (2b).

When the inner container (2) is placed inside the outer container (1), the drip nozzle (2b) is inserted through the insertion opening (1c) until the position-fixing means (2f) form the lock with the end (1e) of said outer container (1).

### Operation.

By removing the safety cover (4) the pusher (3) can be operated and, in turn, it actuates compressing the drip portion (2c) by ejecting the inner container (2) until the liquid material comes out through the drip opening (2e) of the drip nozzle (2b).

During the operation, the inner container (2) remains fixed with respect to the outer container (1) since, the forced wedge of the position-fixing means (2f) at the end (1e) form a lock which fixes it in that position.

The flat cross-sectional configuration of the outer container (1) and the inner container (2) allow the dropper to be easily carried in pockets, bags, briefcases, etc.

In order to refill the dropper, the inner container is removed (2), its drip nozzle (2b) is applied to the refill liquid material and the filling portion (2d) is compressed and decompressed cross-sectionally by suction.

The eyelet (5d) allows to carry the dropper in means such as key-rings and the holding arm (5c) allows it to be held in any pocket.

It can be appreciated that when the present utility model is put into practice, modifications may be introduced regarding certain construction and shape details, without departing from the fundamental principles which are clearly stated in the following claims.

I claim:

1. A refillable dropper suitable for the dosified delivery of liquid material of any viscosity, comprising:
an inner container being at least partially elastically deformable and having an end with a drip nozzle;
an outer container structurally arranged for housing said inner container and having an insertion opening at one end thereof, and wherein the cross-sectional configuration of said outer container determines the cross-sectional configuration of said inner container;
a pusher member engageable with said inner container by means of a to-and-fro motion within said outer container to compress said inner container to thereby eject liquid material through said drip nozzle;
wherein said inner container includes at least two elastically deformable portions comprised of an ejection drip portion and a suction filling portion; and
wherein said inner container includes position-fixing means which fix said inner container with respect to said outer container when said inner container is positioned within said outer container.

2. The refillable dropper in accordance with claim 1, wherein the position-fixing means is located on the drip nozzle, and project outwardly therefrom, such that the insertion of said inner container into the insertion opening of the outer container provides a lock between said position-fixing means and the end of said outer container.

3. The refillable dropper in accordance with claim 1, wherein the position-fixing means are ledges on the drip nozzle.

4. The refillable dropper in accordance with claim 1, wherein the position-fixing means are recesses in the drip nozzle.

5. The refillable dropper in accordance with claim 3, wherein the position-fixing means is a set of ledges.

6. The refillable dropper in accordance with claim 3, wherein the position-fixing means is a ring recess.

7. The refillable dropper in accordance with claim 3, wherein the position-fixing means is a recess with a smaller mouth edge.

8. The refillable dropper in accordance with claim 1, wherein the outer container includes openings at opposing ends; with said openings consistong in an ejection opening, where the pusher is located, and a drip opening; wherein said drip opening has a shape which enables the drip nozzle of the inner container to run though it by means of forces insertion; and said forced insertion is due to the position-fixing means which engages the end of said outer container in order to form a lock with said inner container.

9. The refillable dropper in accordance with claim 1, wherein the outer container, the cross-sectional configuration of which is flat, houses an inner container of flat cross-sectional configuration, at least, at its deformable portions.

10. The refillable dropper in accordance with claim 1, wherein the flat inner container comprises:
an ejection drip portion which, folded as a bellows, operates longitudinally in said inner container;
a flat suction filling portion which operates cross-sectionally in said inner container; and
a drip nozzle provided with position-fixing means actuating with respect to the outer container.

11. The refillable dropper in accordance with claim 8, wherein said pushing end provides a connection with a safety cover and said drip end provides a connection with a protection cap and acts with the position-fixing means of the inner container in order to fix said inner container, with respect to said outer container.

12. The refillable dropper in accordance with claim 1, wherein both the outer container and the inner container have a rectangular flat cross-sectional configuration.

13. The refillable dropper in accordance with claim 1, wherein both the outer container and the inner container have a round cross-sectional configuration.

14. The refillable dropper in accordance with claim 1, wherein both the outer container and the inner container have a polygonal cross-sectional configuration.

15. The refillable dropper in accordance with claim 1, wherein the pusher is a substantially rigid member which actuates on the substantially elastic inner container.

16. The refillable dropper in accordance with claim 1, which comprises pusher retention means inside the cavity of the outer container.

17. The refillable dropper in accordance with claim 16, wherein the retention means which actuate reciprocally consist of an inner flange of the outer container and an outer flange of the pusher.

18. The refillable dropper in accordance with claim 1, which comprises a substantially non-deformable safety cover which, applied to the outer container, covers the pusher.

19. The refillable dropper in accordance with claim 1, which comprises a protection cap provided with an elastic holding arm.

20. The refillable dropper in accordance with claim 1, which comprises a protection cap provided with an eyelet.

21. The refillable dropper in accordance with claim 19, wherein the holding arm is formed by the protection cap.

22. The refillable dropper in accordance with claim 19, wherein the holding arm is fixed to the protection cap.

23. The refillable dropper in accordance with claim 20, wherein the eyelet is formed by the protection cap.

24. The refillable dropper in accordance with claim 20, wherein the eyelet is fixed to the protection cap.

25. The refillable dropper in accordance with claim 20, which comprises an extension fitting of the drip nozzle.

26. The refillable dropper, wherein the position-fixing means form a coupling stop of an extension fitting at the end portion of the drip nozzle of the outer container.
